(19) United States
(12) Patent Application Publication
(10) Pub. No.: US 2014/0060321 A1
(43) Pub. Date: Mar. 6, 2014

(54) FLUID PUMP PISTON AND PISTON TOOLING ASSEMBLY

(71) Applicant: William H. WHITEFIELD, Houston, TX (US)

(72) Inventor: William H. WHITEFIELD, Houston, TX (US)

(21) Appl. No.: 14/010,233

(22) Filed: Aug. 26, 2013

Related U.S. Application Data
(60) Provisional application No. 61/692,739, filed on Aug. 24, 2012.

(51) Int. Cl. F16J 1/00

(52) U.S. Cl. CPC F16J 1/001
USPC 92/249; 29/888.04; 425/127

(57) ABSTRACT

A piston assembly of a reciprocating pump includes a core having a throughbore, a first annular shoulder, a first radial surface that extends from an upper end of the core to a first annular shoulder, and an elastomeric element disposed about the core, where the elastomeric element has a body including a semi-supported section having a first outer radial surface.

### CROSS-REFERENCE TO RELATED APPLICATIONS

The present application is a non-provisional application claiming priority to U.S. Provisional Patent Application Ser. No. 61/692,739, filed on Aug. 24, 2012, entitled “Fluid Pump Piston and Tooling Assembly,” which is incorporated by reference herein in its entirety.

### STATEMENT REGARDING FEDERALLY SPONSORED RESEARCH OR DEVELOPMENT

Not applicable.

### BACKGROUND

1. Field of the Disclosure

The disclosure relates generally to equipment used in reciprocating pumps. More particularly, the disclosure relates to pistons and methods for forming pistons for use in high pressure reciprocating pumps, such as mud pumps used in oil and gas drilling and production operations.

2. Background of the Technology

In some oil and gas drilling and production operations, well fluid (e.g., drilling fluid, circulation fluid, etc.) may need to be circulated between a drilling or production well site at the surface and a wellbore that extends into a subterranean formation. Circulation of the fluid is often accomplished using a mud pump stationed at the well site. The mud pump may be of one of a multitude of designs but often the mud pump at a well site is a reciprocating pump, such as a duplex or triplex pump. While reciprocating pumps are often used in oil and gas drilling and production operations, they may also be used in other applications that involve high pressure fluids. The well fluid may need to be injected into the wellbore at high pressure and thus the mud pump is often a high pressure pump configured for pressurizing the well fluid to pressures exceeding 1,000 pounds per square inch (psi). The well fluid may include suspended particulates and/or other materials that can lead to erosion and other damage to equipment that it comes in contact with, such as internal components of the mud pump.

Reciprocating mud pumps often feature replaceable components that are exposed to the well fluid (e.g., pistons, cylinder liners, etc.) to aid in reliability and overall cost effectiveness of the operation. In some designs, the piston of the mud pump may include an outer elastomeric material bonded to an inner metallic core. In this design, exposing the elastomeric material to the high pressure well fluid may increase the durability of the piston. Further, the elasticity of the elastomeric material may be used to create an annular seal between an outer diameter (OD) of the piston and an inner diameter of the cylinder of the mud pump. For instance, as the elastomeric material is exposed to pressure from the well fluid, the material may flex radially outwards toward the cylinder liner, creating an annular seal. This configuration may obviate the need for using another means for creating an annular seal about the piston, such as through the use of piston rings, which may not respond well to high pressure well fluid. However, while the use of an elastomeric-metallic bonded design may have advantages over other piston designs, this design presents several challenges. For instance, constant flexing during operation may damage the elastomeric material over time due to elastic hysteresis. The more dependent an elastomeric piston depends on fluid pressure for sealing, the more the elastomeric will need to flex, generating more heat and stress in the material from hysteresis. Further, while the elastomeric material is bonded to the metallic core during the manufacturing process, the elastomeric material may “shrink” or deform in shape about the core, possibly leading to an undesirable shape or profile of the OD of the piston.

Accordingly, there remains a need in the art for apparatuses and methods for increasing the durability and effectiveness of reciprocating pump pistons that include elastomeric material. Such apparatuses and methods would be particularly well received if they reduced stress on the elastomeric material during operation and created a better annular seal between the piston and cylinder liner before energizing with high pressure fluid.

### SUMMARY

For a detailed description of the disclosed embodiments, reference will now be made to the accompanying drawings in which:

In an embodiment, a piston assembly of a reciprocating pump may generally include a core having a throughbore extending entirely through the core, a first radial surface and a first annular shoulder, where the first radial surface extends from an upper end of the core to the first annular shoulder. This embodiment may further include an elastomeric element disposed about the core, where the elastomeric element has a body including a semi-supported section having a first outer radial surface. The core of the piston assembly may further include a second radial surface and a second annular shoulder, where the second radial surface extends from the first radial annular shoulder to the second radial annular shoulder. The elastomeric element may further include a fully supported section having a second outer radial surface. In this embodiment, the fully supported section of the elastomeric element may be in physical engagement with the first radial surface of the core. Also, this embodiment may further include a cavity disposed annularly between the first radial surface and an inner radial surface of the elastomeric element. The semi-supported section of the elastomeric element may be configured to be radially displaced into the cavity in response to a compressive force applied to the semi-supported section. Also, the outer diameter of the semi-supported section may be greater than an outer diameter of the fully supported section. Further, the outer diameter of the first outer radial surface of the semi-supported section increases moving toward the upper end of the elastomeric element. This embodiment may further include a cylinder liner disposed about the piston assembly, where at least a portion of the first outer surface of the semi-supported section and at least a portion of the outer surface of the fully supported section are in physical engagement with an inner surface of the cylinder liner. Also, the core may further include a third radial surface that extends from the second annular shoulder to a lower end of the core, and the body of the elastomeric element may further include a thin-walled section extending from a lower end of the fully supported section to a lower end of the elastomeric element.

In an embodiment, a tooling assembly for forming a piston assembly may generally include an annular tooling sleeve having a throughbore and an annular inner surface extending between an upper end of the tooling sleeve and a lower end of the tooling sleeve, where the tooling sleeve has a central axis extending between the upper end and lower end of the tooling sleeve. In this embodiment, the inner surface of the tooling sleeve may include a lower section extending upward from the lower end of the tooling sleeve, an upper section extending downwards from the upper end of the tooling sleeve and a middle section extending between the upper section and the lower section, where the lower section of the inner surface is disposed parallel with the central axis of the tooling sleeve. Also, the middle section and upper section of the inner surface may be disposed at an angle relative to the central axis. In this embodiment, the upper section of the inner surface of the tooling sleeve may be disposed at a greater angle relative to the central axis of the tooling sleeve than the middle section of the inner surface. This embodiment may also include a top hat disposed on top of the piston assembly, where an internal annular face of the top hat physically engages the annular face of the piston assembly and where a radial inner surface of the top hat physically engages the outer radial surface of the piston assembly.

In an embodiment, a method of forming a piston assembly includes disposing a piston core within a tooling sleeve, disposing a top hat on an upper end of the piston core, flowing an elastomeric material along an annular flowpath into an inner throughbore of the tooling sleeve, forming an annular elastomeric element about the piston core and forming an annular cavity between an outer radial surface of the piston core an inner radial surface of the elastomeric element. This method may further include disposing an annular body of the top hat about the outer radial surface of the piston core. Also, forming an annular elastomeric element may include forming a body of the element having a fully supported section that radially extends between the outer radial surface of the piston core an inner annular surface of the tooling sleeve. Further, the diameter of the upper section of the inner surface may be greater at the upper end of the tooling sleeve than at a lower end of the upper section. This embodiment may further include a piston assembly disposed within the tooling sleeve and having a central axis coaxial with the central axis of the tooling sleeve, wherein the piston assembly has an upper end with an annular face and an outer radial surface extending downwards from the upper end.

It is to be understood that both the foregoing general description and the following detailed description are exemplary of the disclosure and are intended to provide an overview or framework for understanding the nature and character of the disclosure as it is claimed. The accompanying drawings are included to provide a further understanding of the disclosure and are incorporated in and constitute a part of this specification. The drawings illustrate various embodiments of the disclosure and together with the description serve to explain the principles and operation of the disclosure.

### BRIEF DESCRIPTION OF THE DRAWINGS

For a detailed description of the disclosed embodiments, reference will now be made to the accompanying drawings in which:

FIG. 1 is an exploded view illustrating an embodiment of a piston tooling assembly in accordance with principles disclosed herein;

FIG. 2A is a top view illustrating an embodiment of a piston assembly;

FIG. 2B is a front cross-sectional view along line A-A of FIG. 2A, illustrating the piston assembly of FIG. 2A;

FIG. 3A is a perspective view illustrating an embodiment of a piston core in accordance with principles disclosed herein;

FIG. 3B is a top view illustrating the piston core of FIG. 3A;

FIG. 3C is a perspective cross-sectional view along line B-B of FIG. 3B, illustrating the piston core of FIG. 3A;

FIG. 4A is a perspective view illustrating an embodiment of an elastomeric element in accordance with principles disclosed herein;

FIG. 4B is a top view illustrating the elastomeric element of FIG. 4A;

FIG. 4C is a perspective cross-sectional view along line C-C of FIG. 4B, illustrating the elastomeric element of FIG. 4A;

FIG. 4D is a front cross-sectional view along line C-C of FIG. 4B, illustrating the elastomeric element of FIG. 4A;

FIG. 5A is a perspective view illustrating an embodiment of a tooling sleeve;

FIG. 5B is a top view illustrating the tooling sleeve of FIG. 5A;

FIG. 5C is a front cross-sectional view along line D-D of FIG. 5B, illustrating the tooling sleeve of FIG. 5A;

FIG. 5D is an enlarged view illustrating a portion of the cross-sectional view of FIG. 5C;

FIG. 6A is a perspective view illustrating an embodiment of a top hat;

FIG. 6B is a top view illustrating the top hat of FIG. 6A;

FIG. 6C is a front cross-sectional view along line E-E of FIG. 6A, illustrating the top hat of FIG. 6A;

FIG. 7A is a top view illustrating the piston tooling assembly of FIG. 1;

FIGS. 7B and 7C are cross-sectional views along line F-F of FIG. 7A, illustrating the piston tooling assembly of FIG. 1;

FIGS. 7D-7F are enlarged views illustrating portions of the cross-sectional view of FIG. 7B; and

FIG. 8 is an enlarged view illustrating a portion of a cross-sectional view of another embodiment of a piston core in accordance with principles disclosed herein.

### DETAILED DESCRIPTION OF THE DISCLOSED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

A tooling assembly and a piston assembly are proposed for increasing the durability and effectiveness of the piston of a reciprocating pump. The piston tooling assembly generally includes a tooling sleeve and top hat for bonding elastomeric material (e.g., polyurethane) to a metallic core disposed within the tooling assembly. A piston assembly for use in a reciprocating pump may be formed from the piston tooling assembly, as will be described further herein. The piston assembly is configured to preload the elastomeric material of the piston as it is installed within the cylinder liner of the pump, thus reducing the need for energization of the annular seal via high fluid pressure. Further, the interface between the elastomeric material and metallic core of the piston assembly is configured to reduce stress on the elastomeric material during operation. In particular, the piston assembly is configured to reduce stress and heat produced from elastic hysteresis resulting from the continual flexing of the elastomeric material during operation. Further, the piston assembly is configured to remain flexible enough to allow for ease of installation when inserting the piston assembly into a cylinder liner of a reciprocating pump.

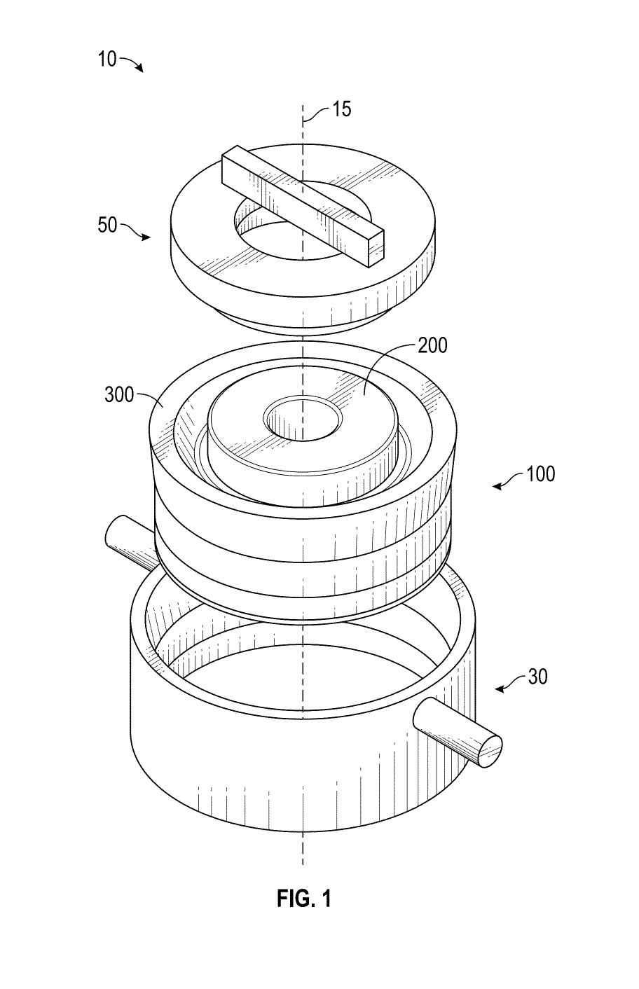

Referring to FIG. 1, an embodiment of a piston tooling assembly 10 includes a tooling sleeve 30 and a top hat 50 sharing a central or longitudinal axis 15. Also, a piston assembly 100 generally includes a piston core 200 and an elastomeric element 300 disposed about core 200, both having central axis 15. The piston assembly 100 generally includes an inner core 200 and an outer elastomeric element 300. In this embodiment, core 200 comprises steel and elastomeric element 300 comprises polyurethane. In other embodiments, core 200 may comprise other metals such as aluminum, titanium and the like and elastomeric element 300 may comprise other materials having elastomeric properties such as rubbers, polymers and the like.

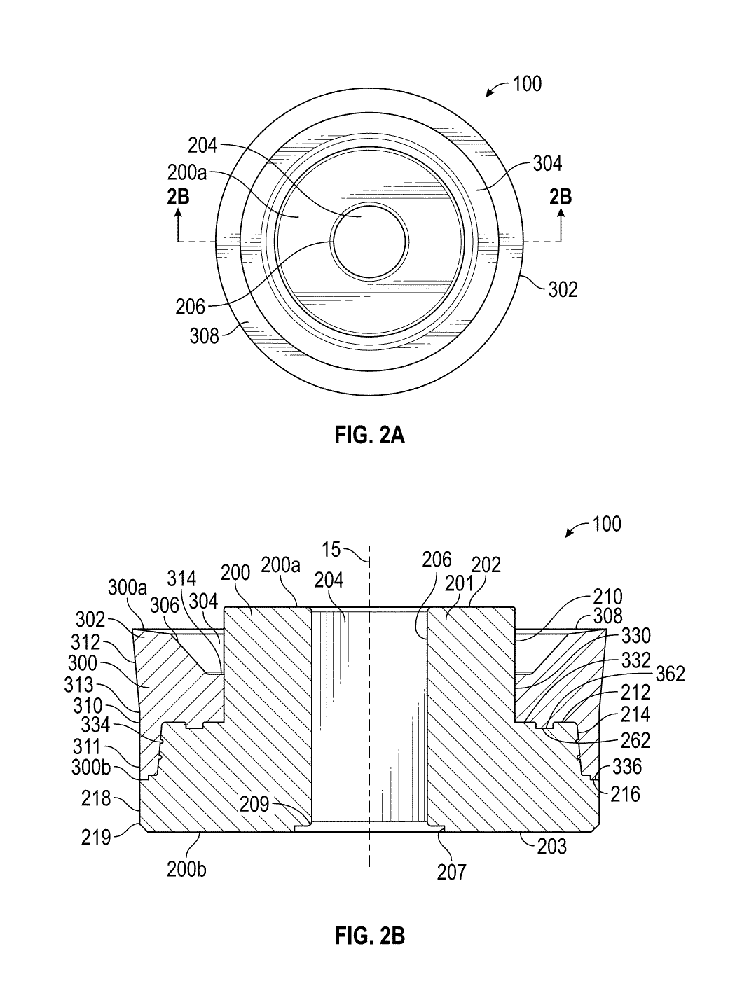

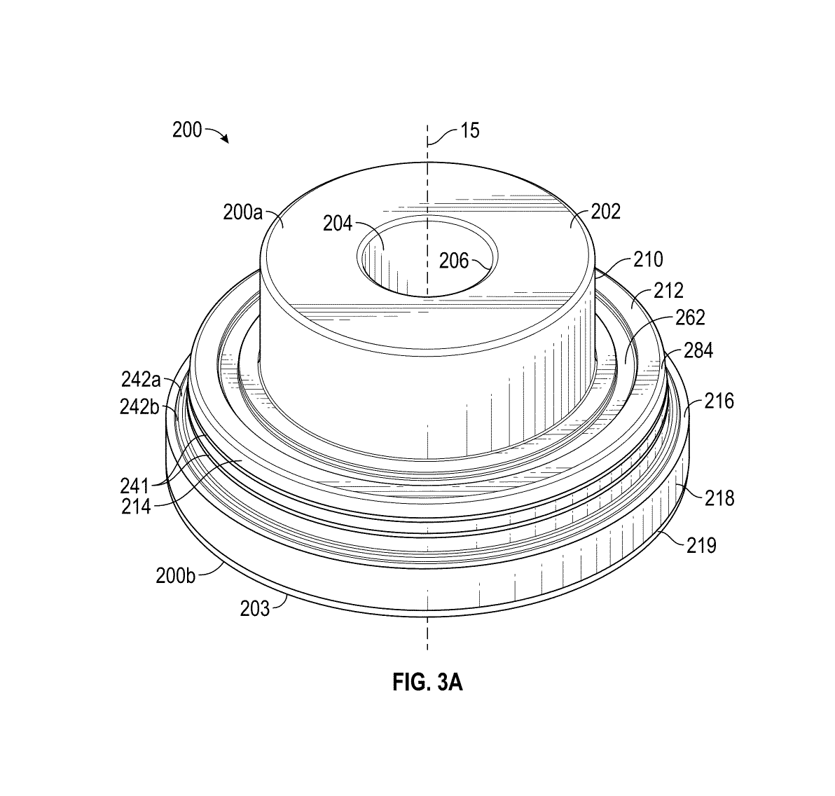

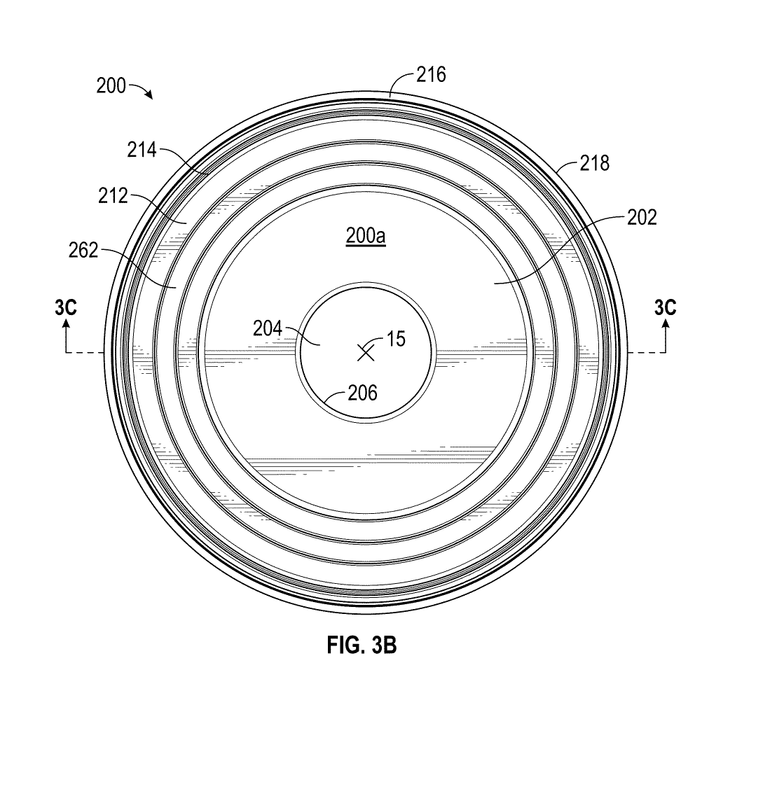

Referring now to FIGS. 2A, 2B and 3A-3C, elastomeric element 300 of piston assembly 100 is bonded to and disposed about core 200. Core 200 has a body 201, an upper end 200a, a lower end 200b and central axis 15. A central bore 204 extends between upper end 200a and second 200b. A first inner diameter (ID) 206 of bore 204 extends into core 200 from upper end 200a and a second inner diameter (ID) 207 of bore 204 extends into core 200 from lower end 200b, forming annular shoulder 209. Upper end 200a and bore 204 combine to form an upper annular face 202. Lower end 200b and bore 204 combine to form a lower annular face 203. An upper radial surface 210 extends from upper end 200a to an upper annular shoulder 212. In this embodiment, radial surface 210 has a substantially constant diameter between upper end 200a and shoulder 212. However, in other embodiments the diameter of radial surface 210 may vary along the axial length of surface 210. A second radial surface 214 extends from first shoulder 212 to a lower annular shoulder 216. As will be discussed further herein, in this embodiment radial surface 214 has a diameter that varies along the axial length of surface 214. A lower radial surface 218 extends from lower annular shoulder 216 to lower end 200b of core 200. A bevel or chamfer 219 extends into lower radial surface 218 at lower end 200b. In this embodiment, the diameter of lower radial surface 218 is substantially continuous between lower annular shoulder 216 and chamfer 219.

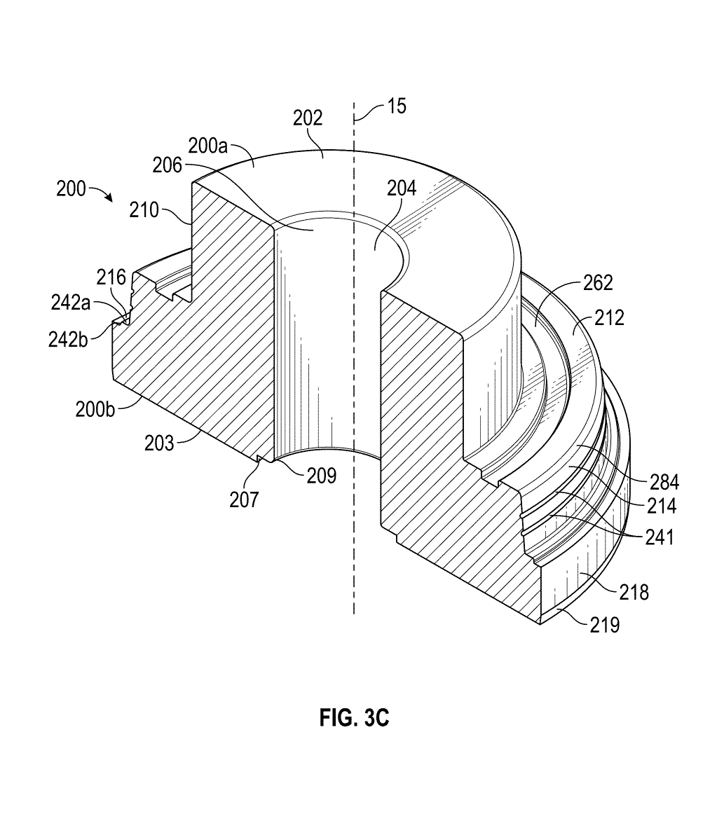

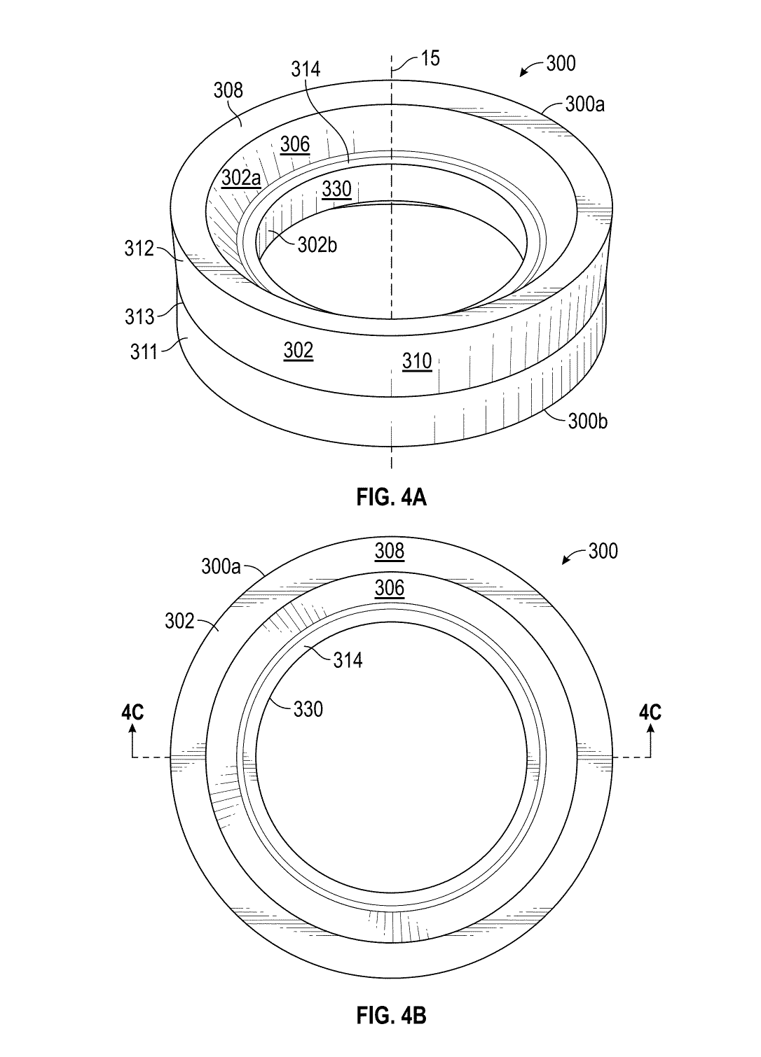

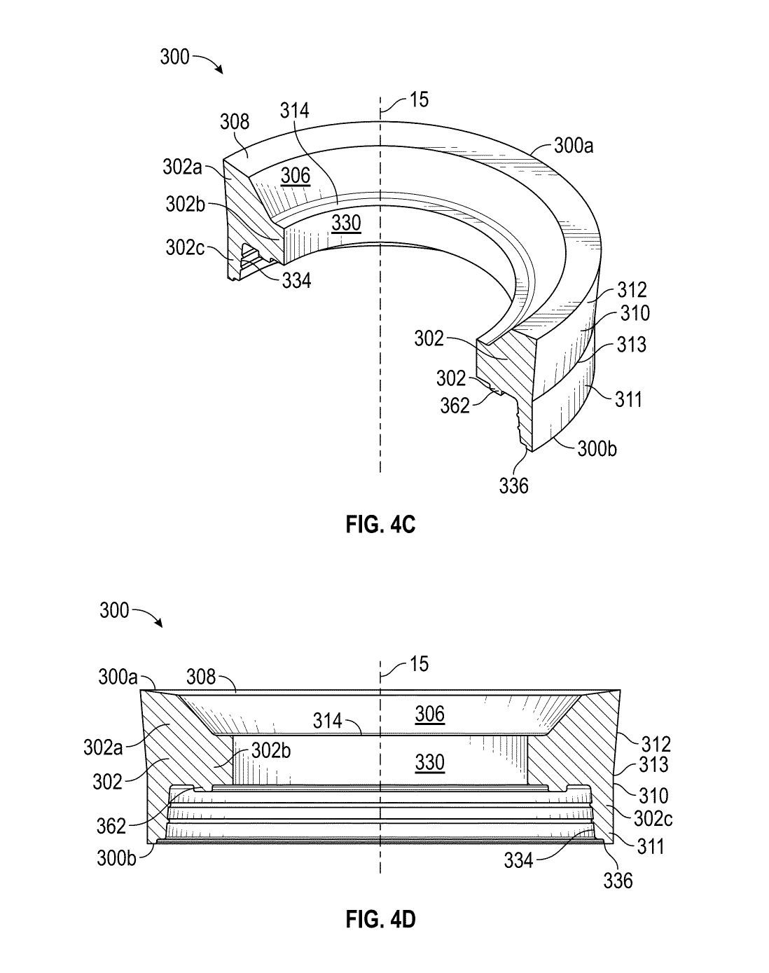

Referring now to FIGS. 2A, 2B and 4A-4D, in this embodiment elastomeric element 300 is bonded to radial surfaces 210, 214, and annular face 212 of piston core 200. Element 300 has a body 302, upper end 300a, lower end 300b and central axis 15. A radial surface 310 extends between upper end 300a and lower end 300b. As will be discussed further herein, radial surface 310 includes a substantially constant diameter section 311 that extends from lower end 300b to a transition point 313, and an increasing diameter (moving from lower end 300b to upper end 300a) section 312 that extends from point 313 to upper end 300a. Thus, the diameter at upper end 300a is larger than the diameter at lower end 300b. As will be discussed further herein, in this embodiment, the diameter of section 311 is substantially equal to an inner diameter (ID) of a cylinder liner to be disposed about the piston assembly 100. However, at least a substantial portion of section 312 has a diameter larger than the ID of the pump's cylinder liner, thus pre-loading at least a portion of the radial surface 310 with a radial force directed inward towards central axis 15.

Referring still to FIGS. 2A, 2B and 4A-4D, an upper annular face 308 is disposed at upper end 300a of element 300. An inner radial surface 306 extends between upper face 308 and a second annular face 314, where face 314 extends between surface 306 and radial surface 210 of core 200. An annular void or cavity 304 is thus formed between inner radial surface 306 of element 300 and radial surface 210 of core 200. The diameter of inner surface 306 decreases as it extends from upper face 308 to second face 314. Thus, the surface 306 is tapered and the thickness of the body 302 of element 300 increases in thickness moving from face 308 to face 314. Due to the gradually increasing thickness, the body 302 of element 300 gradually increases in stiffness and rigidity moving from upper face 308 to second face 314.

An upper inner radial surface 330 extends from second annular face 314 to a third annular face 332. Surface 330 contacts and is in physical engagement with radial surface 210 of core 200. A bonding agent (e.g., an adhesive) configured for bonding elastomers (e.g., polyurethane) to metal is applied to the interface between inner surface 330 and outer surface 210 to further secure the element 300 to the core 200. For instance, bonding the elastomeric element 300 to the metal core 200 may allow the element 300 to resist shear forces (in the direction of axis 15) applied to element 300 as the piston assembly 100 is reciprocated within a pump and radial surface 310 of element 300 slides against an inner surface of the pump's cylinder liner. From the third annular face 332, a lower inner radial surface 334 extends to a lower annular face 336. As with second radial surface 214 of core 200, the diameter of lower inner radial surface 334 increases moving from the third annular face 332 to lower annular face 336 (i.e., in the direction of lower end 300b). Between second annular face 314 and lower end 300b, the thickness of body 302 of element 300 decreases moving toward lower end 300b while the thickness of body 201 of core 200 increases until lower annular shoulder 216, where body 201 spans the entire width or diameter of the piston assembly 100. As with the interface between inner radial surface 330 and radial surface 210, the interfaces between annular faces 332 and 212, and surfaces 334 and 214 include a bonding agent disposed therebetween to further secure the elastomeric element 300 to the metal core 200

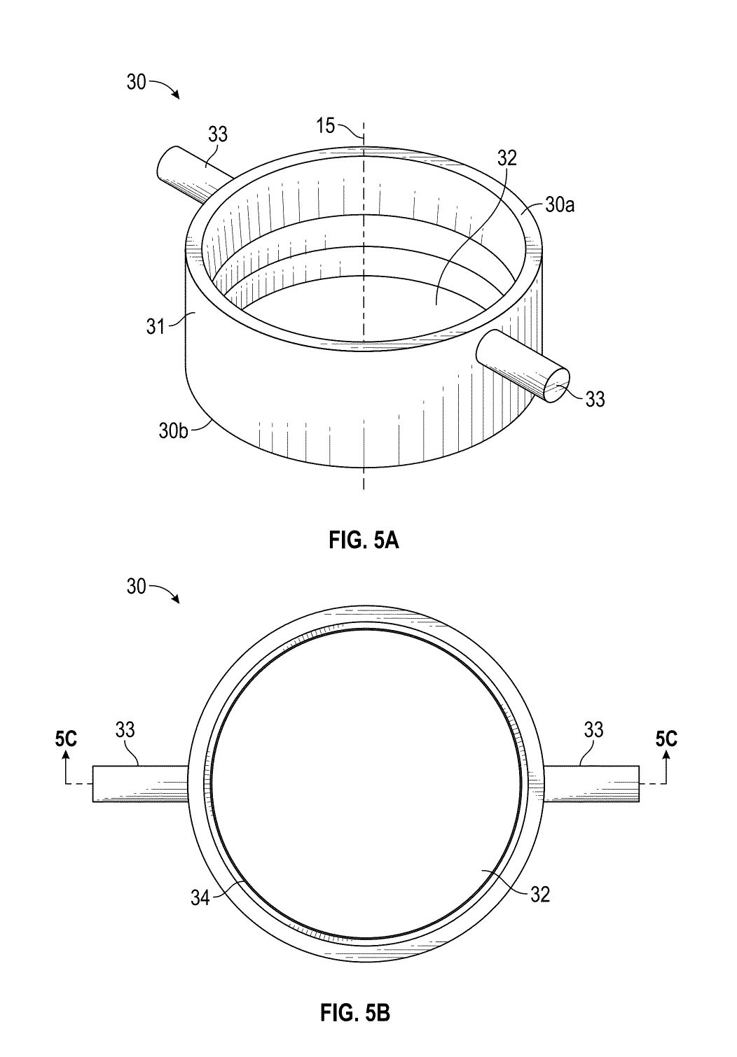

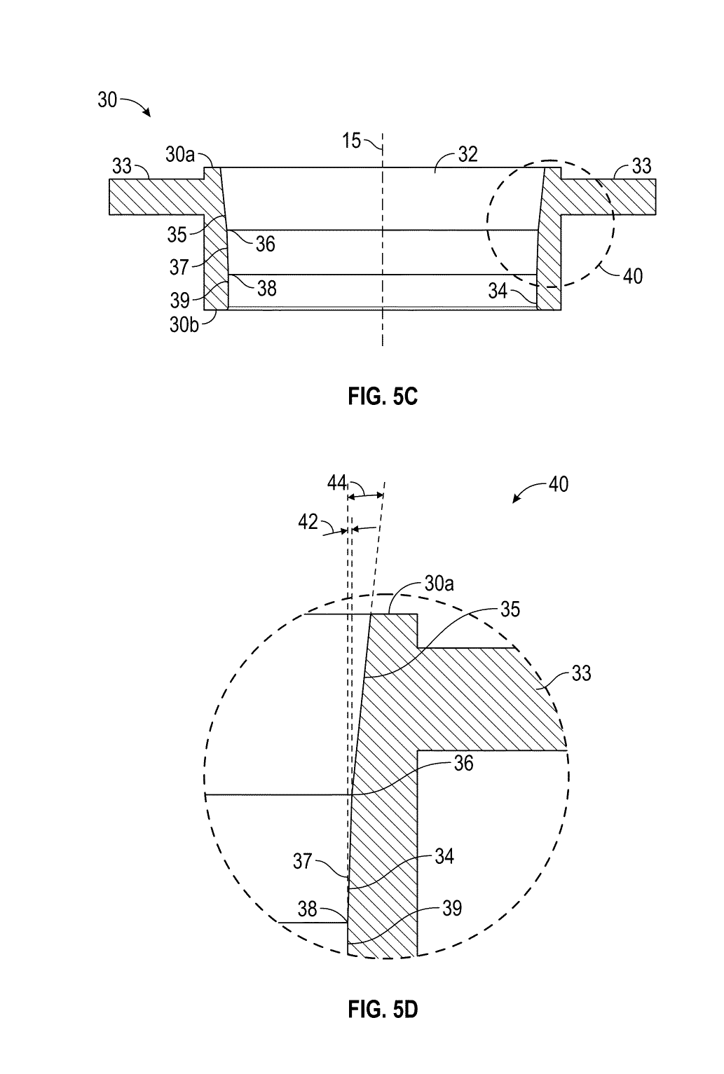

Referring now to FIGS. 5A-5D, tooling sleeve 30 has a body 31, upper end 30a, lower end 30b and central axis 15. Extending radially away from axis 15 on opposing sides of the sleeve 30 are two handles 33 configured to allow for the physical manipulation of the tooling sleeve 30. A central bore 32 extends between upper end 30a and lower end 30b and is disposed coaxially with central axis 15. Bore 32 is defined by an inner surface 34 of the body 31 of sleeve 30. Inner surface 34 is comprised of three sections: an upper section 35 that extends between upper end 30a to a first transition point 36; a middle section 37 that extends between the first transition point 36 and a second transition point 38; and a lower section 39 that extends between the second transition point 38 and the lower end 30b. As shown in the enlarged view of FIG. 5D, the lower section 39 of inner surface 34 has a substantially constant diameter while sections 37 and 35 vary in diameter along their respective axial lengths. For instance, inner surface section 37 is angled at an angle 42 with respect to central axis 15. In this embodiment, angle 42 ranges approximately between 1-4° from parallel with axis 15. Thus, the diameter of bore 32 at point 36 is larger than the diameter of bore 32 at point 38. By way of example, if the diameter of bore 32 at point 38 is 10″, angle 42 is 4° and the axial length between points 36 and 38 (e.g., the length of central axis 15 between points 36 and 38) is 10″, then, using the law of tangents, the diameter of bore 32 at point 36 would be 10.70″. Alternatively, in another embodiment the angle 42 ranges approximately between 1-1.5°. As for the upper section 35 of inner surface 34, section 35 is angled at an angle 44 with respect to central axis 15. In this embodiment, angle 44 is larger than angle 42 and ranges approximately between 4-8° from parallel with axis 15. Thus, the diameter of bore 32 varies a greater degree with respect to axial position at inner surface section 35 than at section 37.

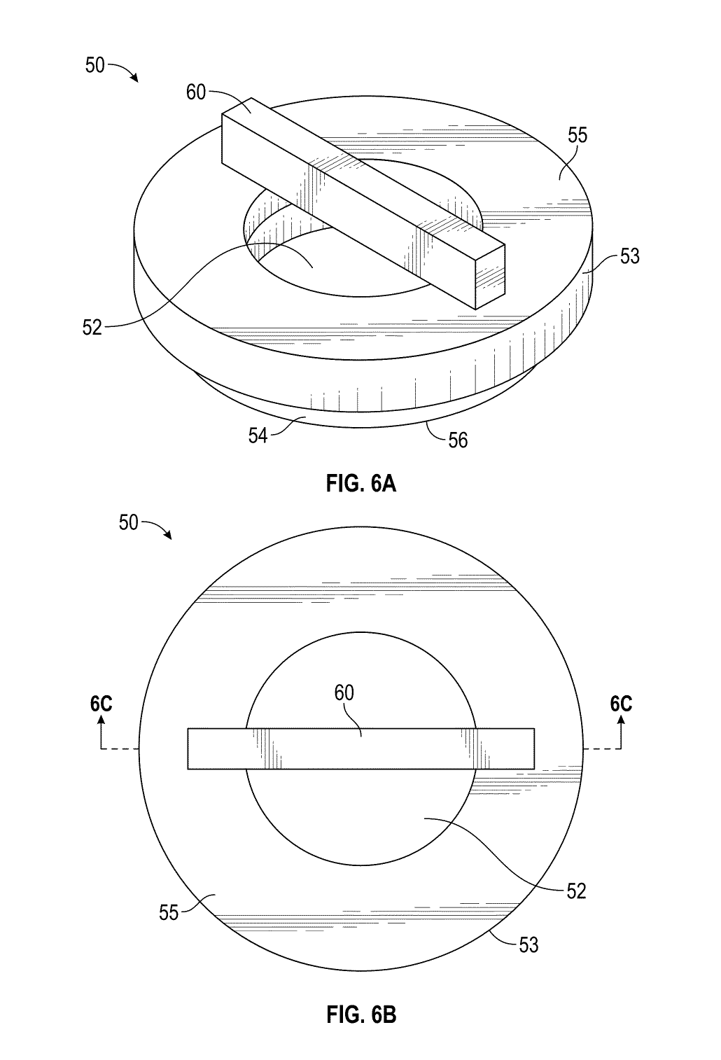

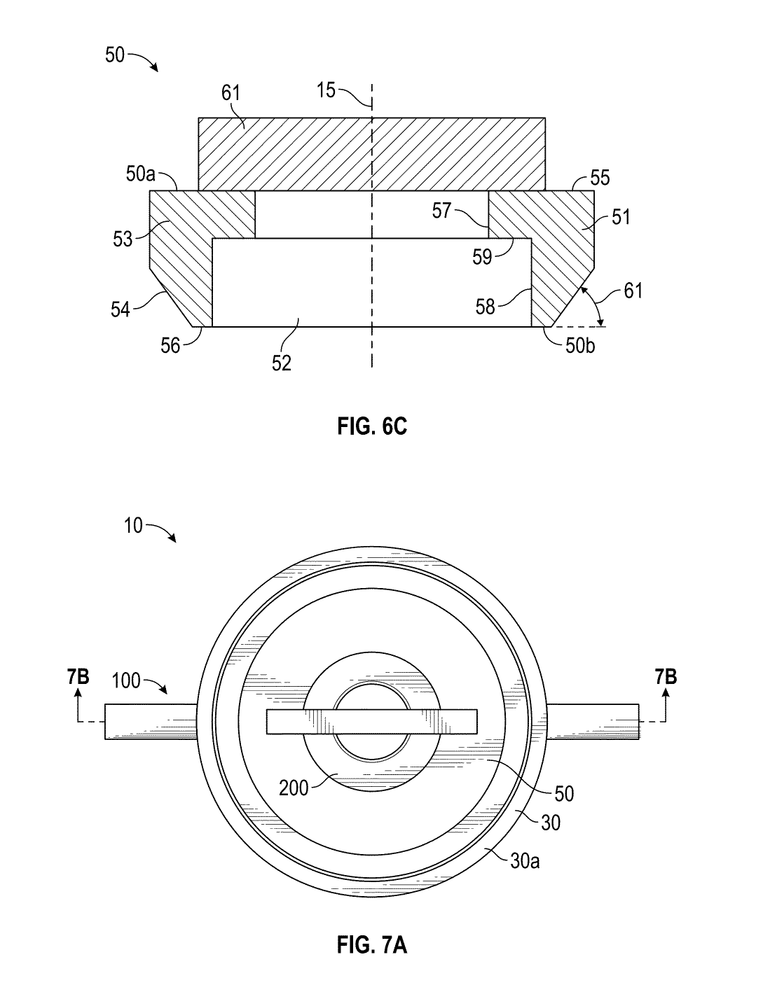

Referring now to FIGS. 6A-6C, the top hat 50 has an upper end 50a, lower end 50b and common central axis 15. Top hat 50 has a body 51 having an OD surface 53 that extends downward from upper end 50a to an outer tapered surface 54 disposed at an angle 61 that extends to lower end 50b. Angle 61 also corresponds to the angle at which surface 306 (FIG. 2B) of elastomeric element 300 is disposed. A central bore 52 defines an upper annular face 55 at upper end 50a while angled outer surface 54 and bore 52 define a lower annular face 56. Central bore 52 extends from upper end 50a to lower end 50b and is defined by an upper ID 57 and a lower ID 58 of body 51. In this embodiment, upper ID 57 is smaller than lower ID 58, and thus an internal annular face 59 is established between ID 57 and ID 58. In the embodiment of FIGS. 6A-6C, angle 61 of outer surface 54 is 48° with respect to the horizontal or radial direction. However, in other embodiments angle 61 may vary between approximately 40-80°. A cross-bar 60 is coupled to the upper annular face 55 to provide a means for handling the top hat 50 during forming of a piston assembly 100. As will be discussed further herein, the radial size (e.g., distance from axis 15) and axial length (e.g., length with respect to axis 15) of OD surface 53, the length of surface 54 and size of angle 61 determine the corresponding geometrical features of elastomeric element 200 of piston assembly 100.

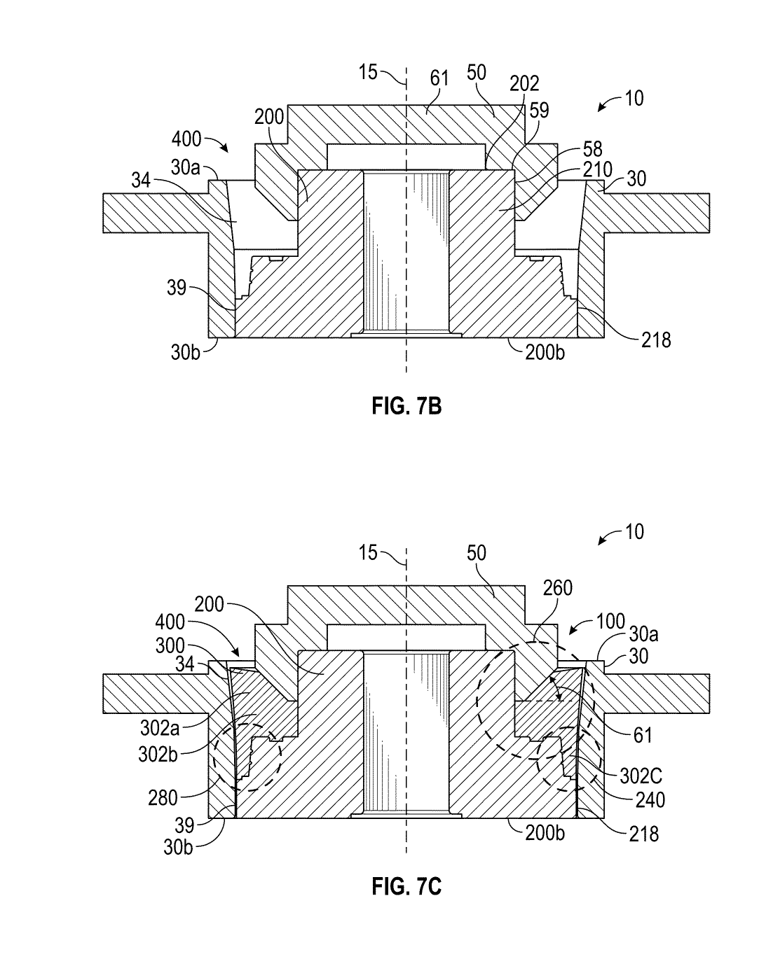

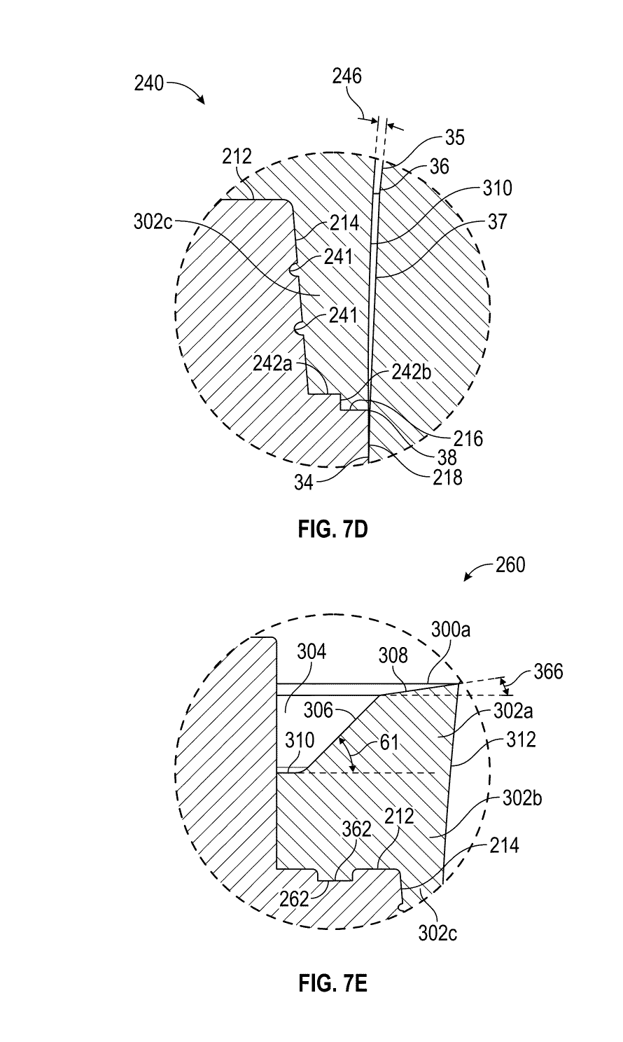

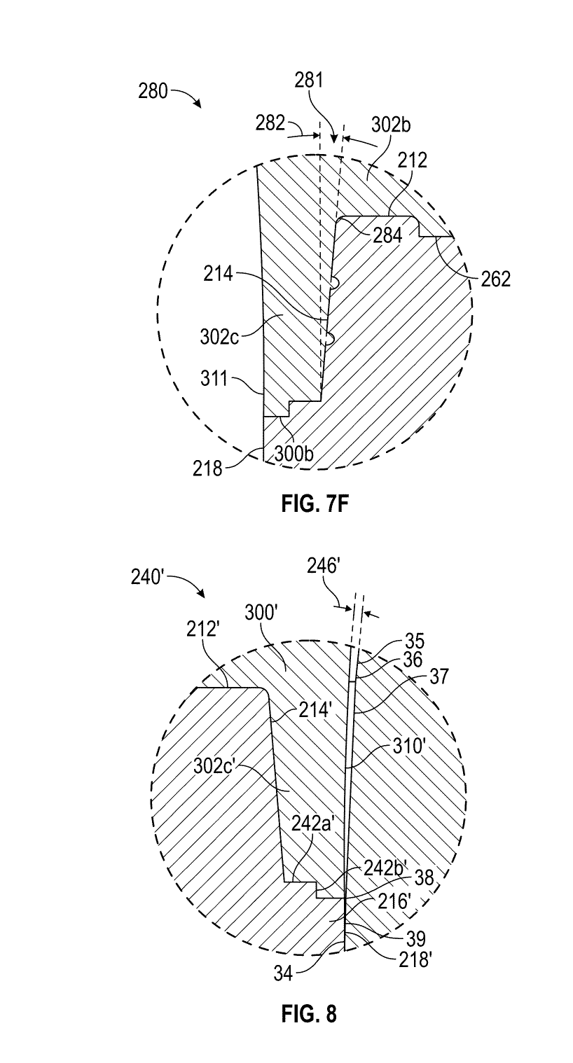

Referring now to FIGS. 7A and 7B, piston tooling assembly 10 is configured to allow for a method of producing piston assembly 100. In this method, core 200 is provided and the outer surfaces thereof are coated and/or treated with a bonding agent to enhance bonding between core 200 and elastomeric element 300. For instance, outer surfaces 210, 212, 214 and 216 (FIGS. 2A and 2B) are coated with the bonding agent. However, in other embodiments, piston assembly 100 may be formed without the use of a bonding agent applied to the interfaces between core 200 and element 300. Top hat 50 may then be placed on top of core 200 via cross-bar 60 such that inner annular face 59 of top 50 physically engages upper annular face 202 of core 200 and lower ID 58 of top hat 50 physically is disposed proximal to upper radial surface 210 of core 200. In this embodiment, a clearance of approximately 0.010-0.020″ is disposed radially between lower ID 58 of top hat 50 and upper radial surface 210 of piston core 200.

Following this, tooling sleeve 30 is provided and core 200 is disposed axially within sleeve 30 such that radial surface 218 of core 200 is disposed proximal section 39 of inner surface 34 of sleeve 30. In this embodiment, a radial clearance of approximately 0.010-0.020″ is disposed radially between section 39 of surface 34 and radial surface 218. Tooling sleeve 30 and core 200 are disposed on a common surface, and thus, the lower end 200b of core 200 is substantially aligned with lower end 30b of sleeve 30. The liquefied polyurethane comprising element 300 may then be added to the tooling assembly 10 via annular flowpath 400. A predetermined amount of liquefied polyurethane is added to tooling assembly 10 via flowpath 400 in order to form elastomeric element 300. For instance, in this embodiment, polyurethane is added to assembly 10 until the material is substantially level with the upper end 30a of tooling sleeve 30. In other embodiments, polyurethane may be added to tooling assembly 10 until there is approximately between 5-50 millimeters between the top of the polyurethane and the upper end 30a of sleeve 30. Upon filling the tooling assembly 10 with the predetermined amount of liquefied polyurethane, the material is allowed to cure within assembly 10 to form element 300. After curing has finished and the polyurethane has hardened to form element 300, top hat 50 is removed and element 300 may be trimmed and machined prior to extracting the finished piston assembly 100 from tooling assembly 10 and installed into a cylinder liner of a reciprocating pump.

Referring now to FIG. 7C, while the polyurethane is liquefied it is in physical engagement with inner surface 34 of sleeve 30; however, as the material cures and solidifies it contracts or shrinks, causing the polyurethane to retract or pull away from the inner surface 34 of sleeve 30. The shrinking of element 300 reduces the diameter of outer radial surface 310, which could lead to the creation of a gap between outer radial surface 310 of element 300 (FIG. 2B) and the inner surface of the cylinder liner. In order to mitigate this issue, sections 37 and 35 (FIG. 5C) of inner surface 34 are angled to increase the internal diameter of surface 34 (FIG. 5C) moving from lower end 30b to upper end 30a of sleeve 30. In turn, the diameter of outer surface 310 of element 300 (FIG. 2B) increases moving from lower end 300b to upper end 300a. Due to the expansion of the diameter of outer surface 310, a gap between surface 310 and an inner surface of the cylinder liner is reduced. Because surface 310 and the cylinder liner are in close proximity forming an interference fit upon installation, the amount of flexing during the power reciprocation of the piston assembly 100 is reduced and in turn the amount of hysteresis stress and heat buildup during operation is decreased.

In another embodiment, piston assembly 100 may be formed using a rubber compression molding process in lieu of the polyurethane curing process described above. In this method, an elastomeric preform would be disposed about the piston core, and both of which would be disposed within a compression mold. In an embodiment, the compression mold is configured similarly to the tooling sleeve 30 and top hat 50, except the top hat 50 and sleeve 30 would be joined in a unitary or integral mold and the body 31 of sleeve 30 would include a greater cross-sectional area to provide additional strength. During the molding process, a relatively high amount of pressure is applied to the elastomeric preform to force the preform to flow into or conform to the shape of element 300, thus forming piston assembly 100. Alternatively, piston 100 may be formed further additional molding procedures, such as transfer molding.

Further, elastomeric element 300 includes a semi-supported annular section 302a, a fully supported annular section 302b and a thin-walled section 302c of body 302. The fully supported section 302b includes the volume of body 302 where body 302 extends completely from outer surface 310 to outer radial surface 210 of core 200 (FIG. 2B). On the other hand, the semi-supported section 302a of body 302 extends from outer surface 310 to an inner surface 306 and cavity 304 (FIG. 2B) that is disposed between surface 306 of element 300 and outer surface 210 of core 200 (FIG. 2B). This hybrid configuration, which includes both semi-supported and fully supported sections, provides a balance between flexibility and stiffness in the elastomeric element 300. For instance, semi-supported section 300a provides flexibility to element 300, allowing for easier installation of piston assembly 100 into the cylinder liner by reducing the outward radial force provided by body 302 as element 300 is “squeezed” into the cylinder liner upon installation. However, fully supported section 302b provides rigidity to the body 302 of element 300, thus inhibiting and/or reducing excessive flexing by element 300 during the operation of the reciprocating pump (e.g., during the power stroke). Further, because section 302b is has an OD that is larger than the ID of the cylinder liner and is fully supported back to the core 200, section 302b provides sealing engagement between element 300 and the inner surface of the cylinder liner.

In this embodiment, the ratio of vertical length along central axis 15 between semi-supported section 302a (i.e., vertical distance between annular faces 308 and 314) and fully supported section 302b (i.e., vertical distance between annular faces 314 and 332) is approximately 0.92-1. However, in other embodiments the ratio in vertical length along central axis 15 between the semi-supported and fully supported sections of body 302 may vary depending on the application. For instance, in another application a more stiff element 300 may be desired, and thus in that application the ratio in vertical length between semi-supported and fully supported sections of body 302 may be less than 0.92-1. For instance, the vertical length of semi-supported section 302a may be decreased relative to the vertical length of fully supported section 302b. However, on the other hand, if a more flexible element 300 is required, the ratio may be greater than 0.92-1. Also, in applications which require a stronger sealing engagement between element 300 and the inner surface of the cylinder, the ratio may be decreased as the fully supported section 302b provides sealing engagement that does require energization via exposure to fluid pressure during operation of the pump.

Also, because inner surface 306 is angled or tapered, there is a gradual increase in stiffness in body 302 moving from upper end 300a to lower end 300b, due to the gradual increase in the cross-sectional area of body 302 moving toward lower end 300b (FIG. 2B). The gradual nature of the increase in stiffness of body 302 mitigates the presence of any stress risers within body 302, thus increasing the durability of element 300. While in this embodiment the angle of surface 306 is 60° (angle 61 of FIG. 6C), in other embodiments angle 61 may be deviated to better serve the application at hand, depending on whether a more or less gradual shift in stiffness is desired.

Referring now to FIG. 7D, enlarged portion 240 details second outer radial surface 214 of the core 200 of piston assembly 100. Radial surface 214 includes a plurality of annular depressions or grooves 241 that extend into the body 201 of core 200 from surface 214. Depressions or grooves 241 are configured to augment bonding between elastomeric element 300 and core 200. During the formation of element 300, liquefied polyurethane flows into the depressions 241, forming protrusions that are locked within each depression 241. The use of depressions 241 thus increases the amount of shearing force applied to outer surface 310 of element 300 in order to separate or tear element 300 from core 200.

However, referring briefly to FIG. 8, in an alternative embodiment a piston core 200′ comprises a generally smooth radial surface 214′ that does not include depressions for engaging an elastomeric element 300′. Correspondingly, thin walled section 302c′ is generally smooth and does not include any protrusions for engaging piston core 200′.

FIG. 7D also illustrates the separation of outer surface 310 of element 300 and inner surface 34 of tooling sleeve 30 that takes place due to the contraction of the polyurethane forming element 300 upon curing. The contraction of the polyurethane of element 300 results in an angle 246 between surface 310 of element 300 and surface 34 of sleeve 30. In this embodiment, the angle of separation 246 is approximately 2°. However, depending on the type of polyurethane used and the radial width of the body 302 of element 300, the angle of separation 246 may vary approximately between 1-10°.

In this embodiment, lower annular shoulder 216 of core 200 includes an annular notch 242 having an annular shoulder 242a and an outer radial surface 242b that is configured to reduce stress in the body 302 at lower end 300b generated by shrinking of element 300 during curing of the polyurethane forming element 300. Second outer radial surface 214 extends from upper annular shoulder 212 to the annular shoulder 242a of notch 242. Outer radial surface 242b extends between annular shoulder 242a and lower annular shoulder 216. The inclusion of notch 242 produces a more gradual transition between thin-walled section 302c where body 302 of element 300 terminates at lower end 300b and outer surface 218, where core 200 extends entirely to the inner surface 34 of tooling sleeve 30. Notch 242 allows for a relatively more gradual reduction in cross-sectional area of annular thin-walled section 302c of element 300, thus mitigating stresses provided by the shrinking of element 300 proximal lower end 300b.

Referring now to FIG. 7E, enlarged portion 260 illustrates upper annular shoulder 212 of core 200. In this embodiment, upper shoulder 212 includes an annular socket 262 that extends into the body 201 of core 200 from shoulder 212. A corresponding protrusion 362 of the body 302 of element 300 is disposed within socket 262. Similar to the depressions 241, socket 262 is configured to strengthen the bonding and/or connection between core 200 and elastomeric element 300. The inclusion of socket 262 results in a greater surface area along annular shoulder 212 for bonding between core 200 and element 300. Also, physical engagement between socket 262 and protrusion 362 resists radial deformation (e.g., moving towards or away from axis 15) of the fully supported section 302b of element 300. For these reasons a greater amount of stress (e.g., shear stress from the cylinder liner) will need to be applied to the elastomeric element 300 in order to separate and/or deform element 300 with respect to core 200 due to the inclusion of socket 262.

Referring still to FIG. 7E, upper annular face 308 is disposed at an angle 366 relative to the radial direction. As piston assembly 100 is displaced through the cylinder liner of a reciprocating pump during operation, a large force is applied to upper annular face 308 and inner radial surface 306 as piston assembly 100 pressurizes and displaces fluid from the fluid end of the pump. As piston assembly 100 is displaced during operation, fluid pressure acts against surfaces 306 and 308 of element 300. Because surface 306 is disposed at angle 60 and surface 308 is disposed at angle 366, respectfully, fluid pressure acting against surfaces 306 and 308 results in a radial force directed outwards against the cylinder liner of the mud pump. The radial force provided by engagement between the fluid and face 308 allows for greater sealing engagement between semi-supported section 302a and the inner surface of the cylinder liner. In this embodiment, upper annular face 308 is disposed at an angle 366 of 7°. However, in other embodiments angle 366 may be adjusted to better fit the given application. In applications demanding greater sealing engagement between semi-supported section 302a and the inner surface of the cylinder liner, angle 366 may be increased to an angle greater than 7°.

Referring now to FIG. 7F, enlarged portion 280 illustrates outer surface 210 of core 200. Second radial outer surface 214 includes a taper 281 such that surface 214 decreases in diameter as it extends from shoulder 216 to upper annular shoulder 212. Thus, surface 214 is disposed at an angle 282 with respect to axis 15 (e.g., surface 214 is not parallel with axis 15). Due to taper 281, the annular thickness of thin-walled section 302c of the body 302 of element 300 increases in annular thickness moving upward from lower end 300b to the fully supported section 302b. As piston assembly 100 is axially displaced within the cylinder during operation, a high amount of flexing occurs within section 302b and a high amount of stress is applied to body 302 of element 300 at the area of transition between thin-walled section 302c and fully supported section 302b. Due to the high level of stress applied to body 302 at this juncture, it may be advantageous to gradually transition between sections 302c and 302b, in order to eliminate or at least mitigate stress risers that may occur due to this transition. Taper 281 allows for a more gradual transition between sections 302c and 302b via gradually increasing the annular thickness of thin-walled section 302c moving upward from lower end 300b, resulting in a greater annular thickness of body 302 in the portion of section 302c proximal to fully supported section 302b. In this embodiment, taper 281 includes an angle 282 of 5°. However, in applications where elastomeric element 300 is placed under higher levels of stress due to the operating environment, angle 282 may be increased beyond 5° to allow for a more gradual transition between thin-walled section 302c and fully supported section 302b.

Further, the transition between radial surface 214 and upper annular shoulder 212 includes a rounded edge or radius 284. Radius 284 also helps to reduce stress risers that result due to the transition between thin-walled section 302c and fully supported section 302b. For instance, without radius 282 as element 300 flexes during operation, the edge formed by the intersection between surface 214 and shoulder 212 may cut into the body 302 of element 300 as fully supported section 302b deforms during operation. Radius 284 thus “softens” the edge formed by the intersection of these two surfaces, reducing the likelihood of core 200 cutting into element 300 at the transition between sections 302c and 302b.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A piston assembly of a reciprocating pump, comprising:
a core, comprising:
a throughbore extending entirely through the core;
a first radial surface; and
a first annular shoulder;
wherein the first radial surface extends from an upper end of the core to the first annular shoulder;
an elastomeric element disposed about the core;
wherein the elastomeric element has a body comprising a semi-supported section having a first outer radial surface.

2. The piston assembly of claim 1, wherein the core further comprises:
a second radial surface; and
a second annular shoulder;
wherein the second radial surface extends from the first radial annular shoulder to the second radial annular shoulder.

3. The piston assembly of claim 2, wherein the elastomeric element further comprises a fully supported section having a second outer radial surface.

4. The piston assembly of claim 3, wherein the fully supported section is in physical engagement with the first radial surface of the core.

5. The piston assembly of claim 1, further comprising a cavity disposed annularly between the first radial surface and an inner radial surface of the elastomeric element.

6. The piston assembly of claim 5, wherein the semi-supported section of the elastomeric element is configured to be radially displaced into the cavity in response to a compressive force applied to the semi-supported section.

7. The piston assembly of claim 3, wherein an outer diameter of the semi-supported section is greater than an outer diameter of the fully supported section.

8. The piston assembly of claim 1, wherein the outer diameter of the first outer radial surface of the semi-supported section increases moving toward the upper end of the elastomeric element.

9. The piston assembly of claim 3, further comprising a cylinder liner disposed about the piston assembly, wherein at least a portion of the first outer surface of the semi-supported section and at least a portion of the outer surface of the fully supported section are in physical engagement with an inner surface of the cylinder liner.

10. The piston assembly of claim 9, wherein a radial compressive force is applied to the fully supported section of the elastomeric element by the inner surface of the cylinder liner.

11. The piston assembly of claim 3, wherein:
the core further comprises a third radial surface that extends from the second annular shoulder to a lower end of the core and wherein the body of the elastomeric element further comprises a thin-walled section extending from a lower end of the fully supported section to a lower end of the elastomeric element.

12. The piston assembly of claim 11, wherein the third radial surface is configured to physically engage an inner surface of a cylinder liner disposed about the piston assembly.

13. The piston assembly of claim 11, wherein the annular thickness of the thin-walled section of the body increases from a lower end of the thin walled-section to an upper end of the thin-walled section.

14. The piston assembly of claim 3, wherein the second radial surface comprises one or more annular depressions extending radially into the core from the second radial surface.

15. The piston assembly of claim 3, wherein the outer diameter of the second radial surface decreases from a lower end of the radial surface to an upper end of the radial surface.

16. The piston assembly of claim 3, wherein the second radial surface of the core is disposed at an angle relative to a central axis of the core.

17. The piston assembly of claim 1, wherein the first annular shoulder comprises an annular socket that extends axially into the core from the first annular shoulder.

18. The piston assembly of claim 2, wherein the second annular shoulder comprises an annular notch that extends axially from the second annular shoulder.

19. The piston assembly of claim 2, wherein:
an annular edge is formed by the intersection of the first annular shoulder and the second radial surface and wherein the annular edge comprises a radius.

20. The piston assembly of claim 3, wherein:
an annular face is disposed at the upper end of the elastomeric element;
the annular face is disposed at an angle relative to the radial direction.

21. A tooling assembly for forming a piston assembly, comprising:
an annular tooling sleeve having a throughbore and an annular inner surface extending between an upper end of the tooling sleeve and a lower end of the tooling sleeve;
wherein the tooling sleeve has a central axis extending between the upper end and lower end of the tooling sleeve;
wherein the inner surface comprises:
a lower section extending upward from the lower end of the tooling sleeve;
an upper section extending downwards from the upper end of the tooling sleeve; and
a middle section extending between the upper section and the lower section;
wherein the lower section of the inner surface is disposed parallel with the central axis of the tooling sleeve;
wherein the middle section and upper section of the inner surface are disposed at an angle relative to the central axis.

22. The tooling assembly of claim 21, wherein the upper section of the inner surface is disposed at a greater angle relative to the central axis of the tooling sleeve than the middle section of the inner surface.

23. The tooling assembly of claim 21, wherein the diameter of the upper section of the inner surface is greater at the upper end of the tooling sleeve than at a lower end of the upper section.

24. The tooling assembly of claim 21, wherein the diameter of the middle section of the inner surface is greater at an upper end of the middle section than at a lower end of the middle section of the inner surface.

25. The tooling assembly of claim 21, further comprising:
a piston assembly disposed within the tooling sleeve and having a central axis coaxial with the central axis of the tooling sleeve;
wherein the piston assembly has an upper end with an annular face and an outer radial surface extending downwards from the upper end.

26. The tooling assembly of claim 25, further comprising;
a top hat disposed on top of the piston assembly;
wherein an internal annular face of the top hat physically engages the annular face of the piston assembly;
wherein a radial inner surface of the top hat physically engages the outer radial surface of the piston assembly.

27. A method of forming a piston assembly, comprising:
disposing a piston core within a tooling sleeve;
disposing a top hat on an upper end of the piston core;
flowing an elastomeric material along an annular flowpath into an inner throughbore of the tooling sleeve;
forming an annular elastomeric element about the piston core;
forming an annular cavity between an outer radial surface of the piston core an inner radial surface of the elastomeric element.

28. The method of claim 27, wherein the annular cavity is formed by disposing an annular body of the top hat about the outer radial surface of the piston core;

29. The method of claim 27, wherein forming an annular elastomeric element comprises forming a body of the element having a fully supported section that radially extends between the outer radial surface of the piston core an inner annular surface of the tooling sleeve.

30. The method of claim 29, wherein the body of the formed elastomeric element has an outer radial surface that is angled relative to a central axis of the piston core.
